(19) United States
(12) Patent Application Publication
(10) Pub. No.: US 2008/0252136 A1
(43) Pub. Date: Oct. 16, 2008

(54) Wheels of Single Component Construction and Method of Making Same

(75) Inventor: Ram Srivats, Chennai (IN)

Correspondence Address: REED SMITH LLP, 2500 ONE LIBERTY PLACE, 1650 MARKET STREET, PHILADELPHIA, PA, 19103, US

(73) Assignee: WHEELS INDIA LIMITED, Chennai (IN)

(21) Appl. No.: 10/585,468

(22) PCT Filed: Jan. 6, 2005
(86) PCT No.: PCT/IN2005/000007

§ 371 Date: Jun. 24, 2008

(30) Foreign Application Priority Data
Jan. 7, 2004 (IN) 013/CHE/2004

(51) Int. Cl. B60B 3/02; B23P 17/00; B21D 22/14

(52) U.S. Cl. 301/63.109; 29/894.324; 72/83

(57) ABSTRACT

This invention relates to a unitary steel wheel as well as the apparatus and method of producing a unitary steel wheel. The unitary wheel comprises wheel rim and disc portions. In one embodiment, the unitary wheel of this invention further comprise a one-piece wheel of 5° and 15° drop center rims, providing a generally circular steel blank from a sheet stock of pre-determined substantially uniform thickness. The bank preferably has a center hole having a predetermined size. The blank is performed in a spinning machine to a predetermined profile and shape. The perform is further spun and flow formed in a spinning machine, the perform being positioned between an outer roll and inner mandrel and held against a clamping plate. The inner mandrel comprises an outboard surface, which conforms to the predetermined inner diameter of the rim. The perform is further processed in the spinning machine to form a final shape and profile of the rim portion comprising a well, inner and outer flange portions, and inner and outer bead-seat portions.

### FIELD OF INVENTION

This invention generally relates to wheels and particularly to wheels used with vehicles. In particular this invention relates to steel wheels and, more particularly, to steel wheels having approximately 5° and 15° drop center rims. Such wheels may be used with any type of vehicle, including but not limited to commercial vehicles. This invention further relates to a method of manufacturing the wheel of this invention.

### BACKGROUND OF THE INVENTION

Specifications for wheels having approximately 5° or 15° taper and profile (where tire contact is involved) drop center rims are generally set forth in international tire and rim standards, manuals, and handbooks such as ETRTO, T&RA and JATMA. These specifications are generally applicable for all types of 5° or 15° drop center rims, as well as other types of wheels. 15° drop center rims are typically used for tubeless tire applications, while 5° drop center rims are generally used for both tube and tubeless applications. Removable flanges are not required for wheels having 5° or 15° drop center rims.

Typically, a fabricated sheet steel wheel having a 5° or 15° drop center rim for a vehicle are fabricated from more than one component. For example, the inner periphery of a separate rim component may be welded or otherwise affixed to a separate central disc component also made of sheet steel. The tire mounts on the outer periphery of the rim supported by the central disc provides a means for attaching to spindle hubs the brake drum or other associated parts of the vehicle. With such wheel construction it is important that the rim and disc, in their assembled relationship, insure (within acceptable tolerances) roundness of the rim and accurate axial alignment of the rim with respect to the disc. Deviations in the roundness of the rim and axial alignment are referred to as “radial” and “axial” run-outs, respectively. In this regard, vehicle manufacturers establish extremely rigid tolerances and run out specifications.

When wheels are manufactured by conventional methods, the rim and discs are normally manufactured as separate components. These two components are then assembled together. The disc is fixed at its outer peripheral flange to the inner periphery of the rim by welding (or other appropriate method) to form the complete wheel assembly. When utilizing the conventional method of making the rims by using a butt-welded hoop made out of a strip of hot rolled steel sections or plate, maintaining acceptable tolerances on the roundness of the rim hoop is extremely difficult due to the localized “kink” in the region of the butt welded joint and the non-uniform spring back during the rim diameter calibration operation. Furthermore, substantial distortion encountered during the welding of the disc and rim requires costly additional corrective steps in the manufacturing process to ensure that the axial alignment between the rim and the disc is held within acceptable limits. Once such distortion has occurred, It generally cannot be completely corrected. A shift in the axial alignment and the localized kink in the rim in the region of the butt welded joint is known to produce first harmonics while the vehicle is running, thus causing vibration and high noise. The axial shift between the disc and the rim also produces imbalance of the wheel causing vehicle disturbance, thumping, vibration and shaking.

Further, when conventional wheels have been run with test overloads to induce failure, fatigue and cracks have often occurred in the center of the disc where the disc is attached to its supporting axle, and in the welds which attach the rim to the disc.

Moreover, a welded wheel assembly does not perform well under the rigors of the balancing and centering of the wheel. In addition, conventional butt-welded rim hoop joints do not always provide the airtight construction necessary for mounting tubeless tires. Welded joints also constitute a weak point in the wheel, which limits the useful life of the wheel.

In addition, it is well recognized that wheels are not only critical to safety in the use of an automotive vehicle, but also being an un-sprung mass has a pronounced effect on vehicle stability and driving comfort.

However, to date, conventional wheel constructions and methods of assembly have not addressed the foregoing issues. Thus, a unitary (also referred herein as “one-piece”) wheel construction which comprises rim and disc portions formed from the substantially contiguous single or unitary piece of substrate material, such as steel, and method for making such a wheel would address the deficiencies found in the conventional wheel construction described above. Additionally, a unitary wheel rim and disc assembly comprising low carbon and high strength steel would lead to a reduction in weight and would facilitate balancing and centering of the wheel. Thus, a unitary wheel rim and disc assembly, and particularly wheel assemblies comprising 5° and 15° drop center rims, would provide improved technical and economic benefits inasmuch as the unitary construction lends itself to cost effective mass production, improved strength, consistency in dimensions and vibration within established tolerances, improvement in the airtight quality of the seal created when tubeless tires are mounted on the wheel, as well as other improved characteristics.

This application claims the priority of both Indian Patent Application No. 012/CHE/04, entitled A METHOD OF MANUFACTURING INTEGRAL WHEEL RIM AND DISC ASSEMBLY OF A 5° TAPER BEAD-SEAT OF FLAT OR SEMI-DROP CENTER RIM AND INTEGRAL WHEEL CONSTRUCTION, filed on Jan. 7, 2004, and Indian Patent Application No. 013/CHE/04, entitled A METHOD OF MANUFACTURING ONE-PIECE WHEEL OF A 5° & 15° DROP CENTER RIMS AND THE ONE-PIECE WHEEL CONSTRUCTION, filed on Jan. 7, 2004, the entire disclosures of which are hereby incorporated by reference as if being set forth in their respective entireties herein.

### SUMMARY OF THE INVENTION

The present invention relates to a steel wheel of substantially unitary construction. The wheel comprises a disc portion and a rim portion substantially contiguous with said disc portion, wherein the wheel is of substantially unitary construction. The invention also relates to an apparatus and method for producing unitary steel wheels. More specifically, the invention relates to a method of manufacturing a steel wheel comprising the steps of forming a disc portion, and forming a rim portion, wherein said rim portion is substantially contiguous with said disc portion and wherein said wheel is of substantially unitary construction.

In one embodiment of the invention, the unitary steel wheel of this invention further comprises a wheel having approximately 5° and 15° drop center rims. This construction lends itself particularly well to mass production and provides wheels which meet the requirements enumerated above. A unitary wheel rim and disc assembly, and particularly an assembly which includes a 5° and 15° drop center rims, requires less material to construct and is substantially simpler to fabricate as there are no parts to assemble and no welding or other steps required to align or affix separate components. However, in some embodiments of this invention, it may be desirable to incorporate some assembled components requiring alignment or affixation. Regardless of the embodiment constructed, however, cost savings are realized with the method for making the wheel of the invention hereof.

Turning now to an embodiment of the invention which comprises a unitary wheel comprising a rim and disc assembly having a 5° taper bead-seat of flat or semi-drop center rim, the wheel construction consists of a substantially contiguous and typically substantially circular blank formed from steel sheet stock of pre-determined and substantially uniform thickness. The blank preferably has a center hole of predetermined size formed therein or otherwise pierced therethrough. The blank is preformed in a spinning machine to a predetermined profile and cylindrical shape. The performed blank is further spun and flow formed in the spinning machine, wherein the preform is positioned between an outer roller and inner mandrel and held against a clamping plate. The inner mandrel comprises an outboard surface which conforms to the predetermined inner diameter of the rim, wherein the rim comprises inner and outer tire bead-seats and an outer flange. The outer roller comprises an outboard surface which conforms to the predetermined inner diameter of the inner flange. The preform's peripheral cylindrical portion is then spun against the outboard surface of the inner mandrel and outboard surface of the outer roller to form the predetermined profile of the well, the inner and outer bead-seats, and inner and outer flanges respectively. The spun rim comprising the predetermined semi-finished well, inner and outer bead-seats, and inner and outer flanges is further processed in a spinning machine in a flow-forming and spinning operation. During this process, the disc portion is centered on the center hole in the spinning machine and clamped against an outer clamping plate. The peripheral portion of the rim is positioned between an inner mandrel and an outer roller. The inner mandrel and outer roller form a surface by which the final profile and shape of the well, inner and outer bead-seats and inner and outer flanges are formed during the spinning and flow forming process.

One aspect of the present invention is a unique spinning and flow forming method for manufacturing unitary steel wheel rim and disc assemblies for vehicles, and particularly for wheels having 5° and 15° drop center rims. This method comprises backward and forward material displacement through the use of a mandrel that is offset against the axis of rotation of the preform. Generally, a circular steel blank formed from sheet stock of pre-determined uniform thickness is provided. The blank preferably has a center hole of a predetermined size is preferably formed or punched therethrough. The blank is placed in a spinning machine and preformed to a predetermined profile and cylindrical shape. The perform is further spun and flow formed in the spinning machine while the preform is positioned between an outer face plate and inner mandrel while being held against a clamping plate. The inner mandrel comprises an outboard surface, which conforms to the predetermined inner diameter of the rim. The rim portion comprises a well, Inner and outer bead-seats and an outer flange. The outer face plate comprises an outboard surface which conforms to the predetermined inner diameter of the inner flange. The cylindrical peripheral portion of the preform is then spun against the outboard surface of the inner mandrel and outboard surface of the outer roller. This step in the spinning process displaces material in backward and forward directions to shape a predetermined profile and form of the well, Inner and outer bead-seats, and inner and outer flanges respectively. The spun rim comprising the predetermined semi-finished well, inner and outer bead seats and inner and outer flanges, is further flow formed and spun in the spinning machine. During this step in the process, the disc portion is centered on the center hole in the spinning machine and clamped against an outer clamping plate. The peripheral portion of the rim is positioned between an inner mandrel and outer shaping rollers. The inner mandrel and outer shaping rollers form an outboard surface which conforms to and forms the final shape of the well, inner and outer bead seats, and the inner and outer flanges.

In another embodiment of the invention, the preform may be subjected to such operations where the center hole, mounting holes and the vent holes are pierced or otherwise formed in the wheel to a predetermined size, preferably before backward and forward spinning of the preform.

After the final rim profiling and shaping operation, the center hole, vent hole, and/or the mounting holes may be machined to predetermined dimensions in a multi drilling machine or by other suitable means. In addition, the inner and outer flanges may be machined to achieve a flat or round radius on the crowned edges of the flanges, which is step is preferably performed after the center, vent and/or mounting holes are machined.

Thus, the present invention provides a unique, low cost method of press forming, spinning and flow forming a unitary, one piece wheel rim and disc assembly, and particularly a vehicle wheel having 5° and 15° drop center rims. The steel blank is formed from sheet stock and is spun and flow formed in a spinning operation which reduces manufacturing costs over conventional methods. The spinning and flow forming technique of this invention employs tools having simple forming surfaces, which minimizes their associated manufacturing cost, as well as repair expenses. The spin forming machine can be easily programmed to form different shapes, such that the present method is especially suited for making specialty and/or low volume wheel designs as well as one-piece type vehicle wheels for bulk manufacturing.

These and other advantages of the invention will be further understood and appreciated by those skilled in the art by reference to this written specification, as well as the claims and appended drawings.

### BRIEF DESCRIPTION OF THE DRAWINGS

The invention will become more readily apparent from the following description of the preferred embodiments therein shown by way of example only, in the accompanying drawings where like numerals designate corresponding parts and features in the various views wherein:

FIG. 1—shows a sectional view of a steel disc blank having a center hole used in constructing the disc component of welded wheels having 5° and 15° drop center rims of the prior art.

FIG. 2—shows a sectional view of a spin and flow formed steel disc component used in constructing welded wheels having 5° and 15° drop center rims of the prior art.

FIG. 3—shows a sectional view of a finished disc component having central, mounting and vent holes used in constructing welded wheels having 5° and 15° drop center rims of the prior art.

FIG. 4—shows a sectional schematic representation of the welded hoop formed from flat plate used in constructing the steel rim component for welded wheels having 5° and 15° drop center rims of the prior art.

FIG. 5—shows a sectional schematic representation of the welded hoop after milling, which hoop is used in constructing the steel rim component for welded wheels having 5° and 15° drop center rims of the prior art.

FIG. 6—shows a sectional schematic representation of the rolling process used in constructing the steel rim component for welded wheels having 5° and 15° drop center rims of the prior art.

FIG. 7—shows a sectional schematic representation of the calibration operation used in constructing the steel rim component for welded wheels having 5° and 15° drop center rims of the prior art.

FIG. 8—shows a sectional schematic representation of the vent hole operation used in constructing the steel rim component for welded wheels having 5° and 15° drop center rims of the prior art.

FIG. 9—shows a sectional schematic representation of the completed assembly of the prior art wheel having a 5° and 15° drop center rim after the disc and rim components are welded together.

FIG. 10—shows perspective and sectional views of the one-piece steel wheel having a 5° and 15° drop center rim in accordance with the present invention, the perspective view showing a section removed to view the cross-sectional profile.

FIG. 11—shows a sectional view of a steel disc blank having a center hole used in constructing one-piece wheels having 5° and 15° drop center rims in accordance with the present invention.

FIG. 12—shows a schematic sectional representation of the first stage of the spinning process used in forming the disc and rim portions of one-piece wheels having 5° and 15° drop center rims in accordance with the present invention.

FIG. 13—shows a schematic sectional representation of the spun wheel from the FIG. 12, wherein mounting and center holes have been formed in accordance with the present invention.

FIG. 14—shows a schematic sectional representation of the spun wheel from FIG. 13 wherein vent holes have been formed in accordance with the present invention.

FIG. 15—shows a schematic sectional representation of the second stage of the forward and backward displacement of material during the spinning process which continues the process of forming the disc and rim portions of one-piece wheels having a 5° and 15° drop center rims in accordance with the present invention.

FIG. 16—shows a schematic sectional representation of the final stage of spinning processes which substantially forms the final profile and shape of the well, the inner and outer bead-seats, and the inner and outer flanges of one-piece wheels having a 5° and 15° drop center rims in accordance with the present invention.

FIG. 17—shows a schematic sectional representation of the machining process for providing substantially flat or rounded edges to the inner and outer flange crown edges of FIG. 16, in accordance with the present invention.

### DETAILED DESCRIPTION OF THE INVENTION

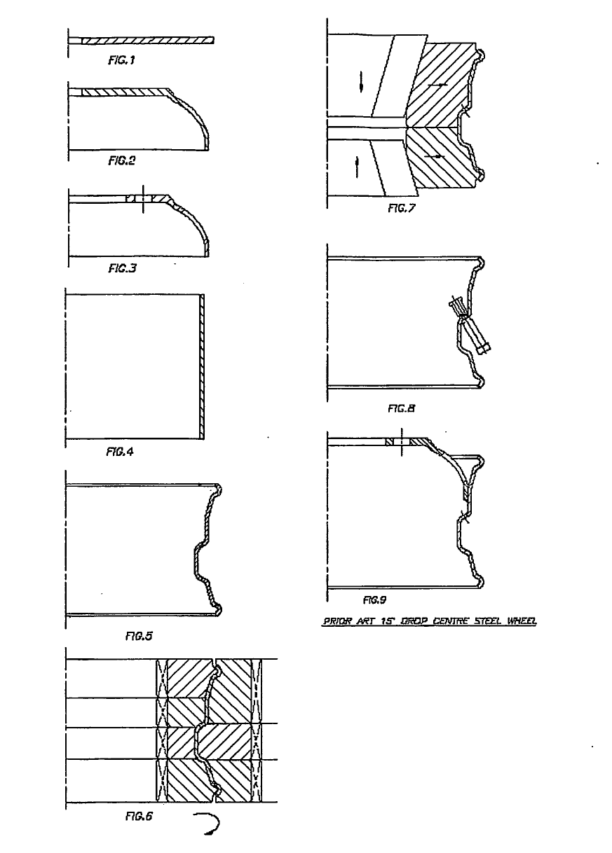

Turning now to FIGS. 1 through 9, the conventional method of manufacturing a steel wheel having 5° and 15° drop center rims is shown. The method requires that the rim and disc are manufactured as single components and then joined together by conventional means such as welding.

The initial steps involved in the manufacture of a conventional steel wheel comprises forming circular blank of pre-determined thickness, press-forming and piercing the center hole, and particularly the mounting and vent holes as, shown for example in FIG. 1, FIG. 2 and FIG. 3.

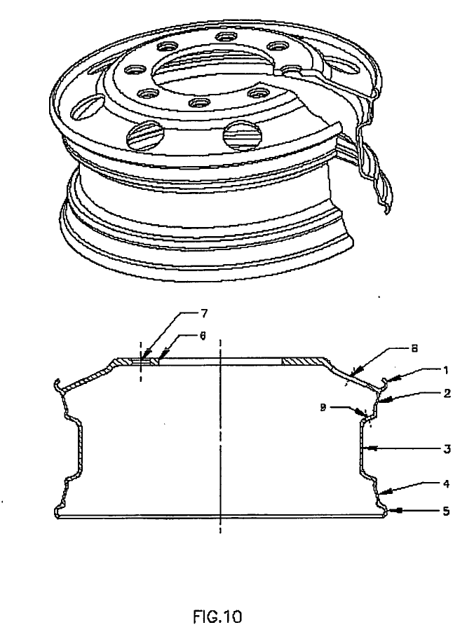

The rim is manufactured either by using a flat plate of uniform thickness or using the profiled hot rolled plate as shown in FIG. 4 and FIG. 5. In either case the plate is coiled into a hoop, butt-welded, joint trimmed and dressed. In the case of a flat plate, the profile of the rim is achieved using either hot or cold press or spinning operations. The rims are then roll formed and calibrated to the diameter within acceptable out-of roundness (run-out) tolerances as shown in the FIG. 6 and FIG. 7. The valve hole is then finished and the valve installed in the steel rim component of the welded wheel construction as shown in FIG. 8.

The finished discs and rims are then assembled in a press or a fixture and the joints are welded or joined by other means after assembly as shown in FIG. 9. The wheels subsequently undergo machining steps to machine and finish the valve, center, vent and mounting holes.

In contrast to the construction shown in FIGS. 1 through 9, the invention disclosed herein relates to a unitary wheel made of metal, such as steel (such as low carbon steel of HSLA steel composition) or other suitable substrate, as well as the apparatus and method of producing a unitary wheel. The unitary wheel comprises both rim and disc portions. The unitary wheel is constructed from a generally circular steel blank formed from sheet stock of pre-determined, substantially uniform thickness. In addition, the blank preferably has a center hole having a predetermined size. In one embodiment, the rim portion further comprises a drop center rim having approximately 5° or 15° bead seats. In an initial fabrication step, the blank is preformed in a spinning machine to a predetermined profile and shape. In a subsequent step, the preform is further spun in a spinning machine to invoke forward and backward displacement of material which continues the process of forming the disc and rim portions of the wheel and, optionally, an inner flange and/or other portions of the wheel. In this subsequent step, the preform is positioned between one or more outer rollers, an inner mandrel and is held against a clamping plate. The inner mandrel comprises an outboard surface which conforms to the predetermined inner diameter of the rim. One or more outer rollers comprise an outboard surface to extend and further form the rim portion and, optionally, an inner flange or other portions. In yet further subsequent steps, the preform peripheral portion is spun against the outboard surface of an inner mandrel and outboard surface of one or more outer rollers to substantially form the final profile and shape of the wheel which may include a well portion, inner and outer flanges, inner and outer bead seats, and/or other desired portions. Subsequent process steps, such as machining of particular portions or components, may then be carried out to complete the manufacturing process.

As we now turn to the embodiment of the invention set forth in FIGS. 10 through 17, it should be noted that the descriptions set forth herein are made for the purpose of illustrating the general principles of this invention and the embodiments specifically referred to herein are offered as non-limiting embodiments of the invention disclosed herein.

One embodiment of the unitary wheel of this invention, as well as an embodiment of the method of making the unitary wheel, is set forth in FIGS. 10 through 17. Turning now to FIG. 10, perspective and sectional views of the wheel of this embodiment are shown. The wheel is of one-piece or unitary construction and is formed from a single piece of substrate material, such as steel or other suitable material. The substrate is of substantially uniform thickness and is usually provided as a substantially round disc having a center hole therethrough and located approximately at the center of the disc. The wheel is formed from the substrate disc into the wheel shown, which wheel comprises a disc portion and a rim portion, which rim portion is substantially contiguous with the disc portion.

The wheel of FIG. 10 (with additional views shown in FIGS. 11 through 17) further comprises inner flange 1 and outer flange 5, each portion of which are formed from the substrate disc and are positioned approximately at opposing ends of the rim portion as contiguous portions of the wheel. Moreover, inner flange 1 is also positioned approximately in the area near where the disc and the rim portions of the wheel meet, while outer flange 5 is positioned approximately at the outer edge of the rim portion. The rim portion further comprises well 3, inner bead seat 2, and outer bead seat 4, each portions of which are also formed from the substrate disc as contiguous elements of the rim portion. Inner bead seat 2 is approximately positioned between inner flange 1 and well 3, while outer bead seat 4 is approximately positioned between outer flange 5 and well 3. In addition, the wheel of FIG. 10 further comprises center hole 6, mounting holes 7, vent holes 8, and valve hole 9. Center hole 6 is positioned approximately in the center of the disc portion of the wheel. Vent holes 8 are approximately positioned near the outer edge of the disc portion and approximately between inner flange 1 and mounting holes 7. Mounting holes 7 are approximately positioned between center hole 6 and vent holes 8. Finally, valve hole 9 is positioned approximately on the outer edge of well 3.

A method of manufacturing the embodiment of the wheel set forth in FIG. 10, is shown in FIGS. 11 through 17. FIG. 11 shows a schematic sectional view of the steel disc substrate having a center hole 6 therethrough prior to forming pursuant to the method of this invention. The blank may be of any size or thickness which permits the wheel to be shaped to the desired dimensions.

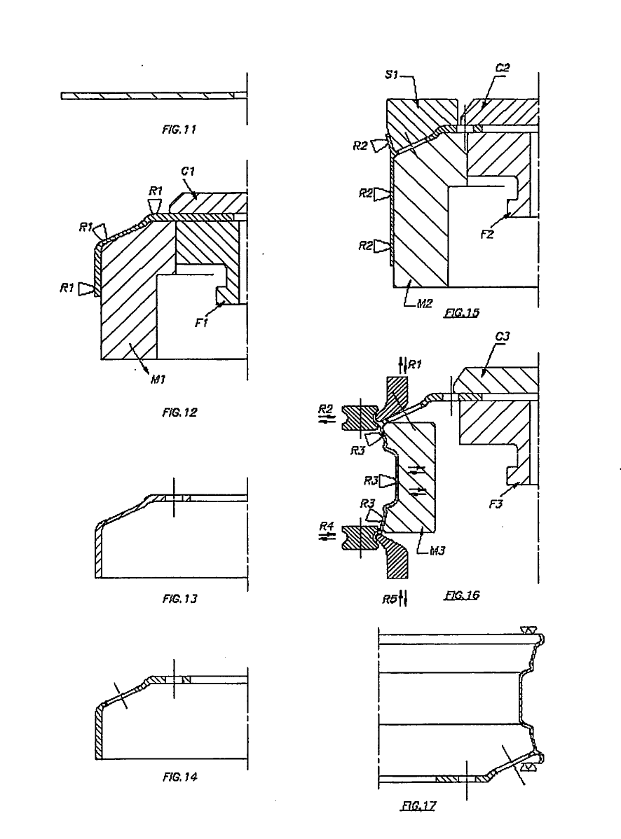

FIG. 12 shows the first step of manufacturing one-piece wheels having 5° and 15° drop center rims which comprise spinning and flow forming the steel disc substrate of FIG. 11. Preferably, the disc is spun and flow formed into a preformed shape in a CNC 4-axis spinning machine or similar device. More specifically, the preform is held between inner mandrel M1, outer roll F1, and clamping plate C1. Shaping rollers R1 are mounted on a hydraulically actuated slide of the spinning machine which imparts a rolling pressure on the outer peripheral portion of the preform. The spinning and rolling pressure reduces the thickness of the disc and rim portions while forming the cylindrical shape and profile in the rim portion of the preform in accordance with predefined settings in the spinning machine. The outboard surface of inner mandrel M1 corresponds to the predetermined cylindrical shape and profile of the inner diameter of the rim portion. Furthermore, this step may comprise one or more passes of shaping rollers R1 to produce the desired shape and profile of the preform.

FIG. 13 shows a cross sectional view of central hole 6 and a mounting hole 7, while FIG. 14 shows a cross sectional view of central hole 6, a mounting hole 7, and a vent hole 8. In a subsequent step or steps schematically depicted in FIGS. 13 and 14, each of mounting holes 7 and vent holes 8 are formed into the preform by conventional methods such as by a press or other means.

FIG. 15 shows yet another subsequent step wherein the preform is subjected to forward spinning extends and further forms the rim portion comprising well 3, inner bead seat 2, outer bead seat 4 and outer flange 5 into a cylindrical shape of desired thickness, diameter and width. Also, during forward spinning the rim portion comprising inner flange 1 is spun in such a way that the material is displaced in a backward direction, also to a predetermined thickness, diameter and width.

More specifically, FIG. 15 discloses a subsequent step wherein the preform is spun and flow formed in a CNC 4-axis spinning machine or similar device. The preform is positioned between inner mandrel M2, shaping mandrel S1 and outer roll F2, and is clamped prior to spinning by clamping plate C2. Shaping rollers R2 are mounted on a hydraulically actuated slide of the spinning machine which imparts a rolling pressure on the outer peripheral portion of the preform. The spinning and rolling pressure further reduces the thickness of the disc and rim portions while forming and extending the cylindrical shape and profile of the rim portion to a desired thickness, diameter and width in accordance with predefined settings in the spinning machine. The outboard surface of inner mandrel M2 corresponds to the predetermined cylindrical shape and profile of the inner diameter of the rim portion, while the outboard surface of shaping mandrel S1 corresponds to the predetermined inner diameter of inner flange 1. Shaping rollers R2 are used for both forward and backward spinning to form the outer surfaces of the rim portion and inner flange 1.

FIG. 16 shows yet another subsequent spinning and forming step which produces substantially the final profile of the disc and rim portions of the wheel. In this step, the preform of FIG. 15 is subjected to additional spinning and shaping to form substantially the final profile and shape of well 3, inner bead seat 2, outer bead seat 4, inner flange 1 and outer flange 5 of desired thickness, diameter and width.

More specifically, FIG. 16 discloses a subsequent spinning and forming step wherein the preform of FIG. 15 is spun and formed in the spinning machine or similar device. Prior to spinning in this step, the preform is positioned between inner mandrel M3 and outer roll F3, and is clamped by clamping plate C3. The disc portion is positioned in the spinning machine such that the centerline of inner mandrel M3 is slightly offset in relation to the centerline of center hole 6 of the perform. The outboard surface of inner mandrel M3 corresponds to the final profile of well 3, inner bead seat 2 and outer bead seat 4. Shaping rollers R3 are mounted on a hydraulically actuated slide of the spinning machine which impart a rolling pressure on the outer peripheral rim portion of the preform to form well 3, inner bead seat 2 and outer bead seat 4. In addition, shaping rollers R1, R2, R4 and R5 substantially form the final profile and shape of inner and outer flanges 1 and 4, respectively.

FIG. 17 shows a cross section of the profile of the final form and shape of the disc and rim portions after the final rim profiling and shaping operation. More specifically, center hole 6, vent holes 8, mounting holes 7, and/or valve hole 9 may be machined to predetermined dimensions in a multi drilling machine or by other suitable means. In addition, the inner and outer flanges may be machined to a desired final shape, such as for example, flat or round radii on the crowned edges of the flanges. This final machining step is preferably, but not necessarily, performed after center hole 6, vent holes 8, mounting holes 7, and/or valve hole 9 are machined.

It is to be understood that the invention discussed herewith may assume various alternative embodiments and methods of manufacture. It is also to be understood that the specific devices and processes illustrated in the attached drawings, and described herein are merely exemplary embodiments of the inventive concepts defined by the appended claims. Hence, specific dimensions and other physical characteristics relating to the embodiments disclosed herein are not to be considered as limiting.

Further, since numerous modifications and changes will readily occur to those skilled in the art, it is not desired to limit the invention to the exact construction and operation shown and described, and accordingly all suitable modifications and equivalents may be regarded as falling within the scope of the invention as defined by the claims that follow.

What is claimed is:

1. A wheel comprising:
a disc portion; and
a rim portion substantially contiguous with said disc portion wherein said wheel is of substantially unitary steel construction.

2. The wheel of claim 1, further comprising a flange portion which is substantially contiguous with said rim portion.

3. The wheel of claim 1, further comprising a well portion, which is substantially contiguous with, said rim portion.

4. The wheel of claim 1, further comprising a bead-seat portion, which is substantially contiguous with, said rim portion.

5. The wheel of claim 4, wherein said bead-seat has about a 5° or 15° taper.

6. The wheel of claim 5, wherein said wheel has a 5° or 15° drop center rim.

7. The wheel of claim 1, further comprising an inner flange portion and an outer rim portion, wherein said inner and outer flange portions are substantially contiguous with said rim portion.

8. The wheel of claim 1, further comprising an inner flange portion and an outer flange portion, wherein said inner and outer flange portions are substantially contiguous with said rim portion and are positioned approximately at opposing ends of said rim portion; a well portion substantially contiguous with said rim portion; an inner bead seat portion substantially contiguous with said rim portion; and an outer bead seat portion substantially contiguous with said rim portion, wherein said inner bead seat portion is approximately positioned between said inner flange portion and said well portion, and wherein said outer bead seat portion is approximately positioned between said outer flange portion and said well portion.

9. The steel wheel of claim 1, wherein said disc portion has a center opening therethrough.

10. The wheel of claim 1, wherein said disc portion has at least one mounting opening the therethrough.

11. The wheel of claim 1, wherein said disc portion has at least one vent opening therethrough.

12. The wheel of claim 1, wherein said disc portion has at least one valve opening therethrough.

13. The wheel of claim 1, substantially mounted to a vehicle.

14. The wheel of claim 1, further comprising a tire substantially mounted to said wheel.

15. A method of manufacturing a wheel comprising the steps of:
forming a disc portion; and
forming a rim portion wherein said rim portion is substantially contiguous with said disc portion and wherein said wheel is of substantially unitary steel construction.

16. The method of claim 15, wherein said wheel is formed from steel stock of substantially uniform thickness.

17. The method of claim 15, further comprising the step of forming a flange portion, wherein said flange portion is substantially contiguous with said rim portion.

18. The method of claim 15, further comprising the step of forming a well portion, wherein said well portion is substantially contiguous with said rim portion.

19. The method of claim 15, further comprising the step of forming an inner flange portion and an outer flange portion, wherein said flange portions are substantially contiguous with said rim portion.

20. The method of claim 15, further comprising the step of forming a bead-seat portion, wherein said bead-seat portion is substantially contiguous with said rim portion.

21. The method of claim 20, wherein said bead-seat is formed with about a 5° or 15° taper.

22. The method of claim 21, wherein said wheel is formed with a drop center rim.

23. The method of claim 15, further comprising the step of forming a center opening in said disc portion.

24. The method of claim 15, further comprising the step of forming at least one mounting opening in said disc portion.

25. The method of claim 15, further comprising the step of forming at least one vent opening in said disc portion.

26. The method of claim 15, further comprising the step of forming at least one valve opening in said disc portion.

27. The method of claim 15, wherein said forming steps comprise at least one of spinning and/or flow forming processes.

28. The method of claim 15, wherein said method utilizes a spinning machine.

29. A wheel of unitary steel construction produced in accordance with the method of claim 15.

30. A method of manufacturing a one-piece wheel of 5° and 15° drop center rim of the type having well, inner & outer bead-seat and flanges wherein the said method comprises the following steps:
a. Providing a generally circular steel blank;
b. The blank is preferably of pre-determined uniform thickness;
c. The blank is preferably with a center hole pierced to a predetermined size;
d. The blank is preformed to a predetermined cylindrical shape & size by spinning & flow forming in a CNC spinning machine, the blank being positioned & clamped between a inner mandrel and a clamping plate, such inner mandrel having a outboard surface which conforms to an predetermined inner diameter wherein the well, inner & outer bead seats and the outer flange are formed in the subsequent operations;
e. The spun and flow formed preform to an predetermined cylindrical shape & size is further spun in a CNC spinning machine to reduce thickness consequently to increase the width in the forward direction to an predetermined size while maintaining the predetermined inner diameter wherein the well, inner & outer bead seats and the outer flange are formed in the subsequent operations and at the same time further spinning is preformed on the peripheral portion of the cylinder to displace the material in the backward direction to a predetermined shape & size of the inner flange; and
f. The perform from the previous step, is further spun in a CNC spinning machine to impart final shape and profile to the rim portion comprising of well, inner & outer bead seats and inner & outer flanges using such inner mandrel, the central line axis of which is slightly offset against the centerline of the central hole of the perform during spinning operation.

31. The method as claimed in claim 30 wherein spin forming the peripheral of the blank by engaging the same with a forming roller so as to obtain controlled thickness reduction and shape in the peripheral and inner portion of the blank.

32. The method as claimed in claim 30 wherein the material is displaced in the backward direction during spinning a portion of the perform peripheral cylindrical portion against the outboard surface of an outwardly positioned outer roll to form a predetermined cylindrical portion of the inner flange.

33. The method as claimed in claim 30 wherein spin forming a portion of the blank peripheral portion by engaging the same with a forming roller to form the final shape of the well.

34. The method as claimed in claim 30 wherein spin forming a portion of the blank peripheral portion by engaging the same with a forming roller to form the final shape of the bead seat.

35. The method as claimed in claim 30 wherein spin forming the bead seat portion of the perform blank by engaging the same with a forming roller against the outboard surface of the outer mandrel to form the final shape of outer flange.

36. The method as claimed in claim 30, wherein: said first-named spin forming step consists a plurality of passes of the forming roller.

37. The method as claimed in claim 30 wherein after finish spinning operation bolt holes are pierced in a conventional press.

38. The method as claimed in claim 30 wherein after piercing the center hole, bolt holes, vent holes are pierced in a conventional press.

39. The method as claimed in claim 30 wherein after piercing the center, bolt holes & vent holes, the center hole and the mounting holes are accurately machined to required size.

40. The method as claimed in claim 30 wherein after machining the center hole and the mounting holes to an accurate required size, the inner & outer flange crown edges are machined to provide a radius or a flat.

41. The method as claimed in claim 30 wherein said step (a) consists the step of providing a disc blank of substantially uniform thickness of low carbon steel or HSLA steel composition.

42. The method as claimed in claim 30 wherein a butt-welded hoop of predetermined diameter, width and thickness can also be used instead of a blank.

43. The method as claimed in 39 wherein the butt-welded hoop of predetermined diameter, width and thickness can also be used to manufacture the rim part alone.

44. The method as claimed in 39 wherein the butt-welded hoop of predetermined diameter, width and thickness can also be used to manufacture of the rim part alone.

45. Apparatus for manufacturing a one-piece wheel of 5° and 15° drop center rim of the type having an integral disc and rim portion well, inner & outer & inner bead-seat and fixed flanges wherein the said method comprises means for providing a generally circular blank means for forming the blank to of pre-determined uniform thickness the blank is preferably with a center hole pierced to a predetermined size, the blank is pre-formed in a spinning machine, the pre-form blank further spun in a spinning machine, being positioned between an mandrel and clamping plate, such mandrel having a outboard surface which conforms to the shape of the well, inner & outer bead seat & fixed flanges, the blank peripheral & inner portions is spun and flow formed against the outboard surface of the inner mandrel and shaping rolls to form the final shapes of the rim comprising of well, bead seat and flanges

46. Apparatus for manufacturing a one-piece wheel of 5° and 15° drop center rim for a vehicle having an integral disc and rim portion comprising of well, bead seats and flanges manufactured by the process claimed in claim 30.

47. A one-piece wheel of 5° and 15° drop center rim for a vehicle having an integral disc and rim portion as claimed in claim 30 comprising of well, bead seat and flanges wherein when spin forming machine is programmed to form different shapes.

48. A method of manufacturing a one-piece wheel of 5° and 15° drop center rim for a vehicle having an integral disc and rim portion as claimed in claim 30 comprising of well, bead seat and flanges as described in the description of complete specification and as illustrated by way of drawings accompanying the complete specification.

49. A one-piece wheel of 5° and 15° drop center rim for a vehicle having an integral disc and rim portion as claimed in claim 1 comprising of well, inner and outer bead seats and inner and outer flanges as described in the description of complete specification and as illustrated by way of drawings accompanying the complete specification.

50. A one-piece wheel of 5° and 15° drop center rim for a family of vehicle wheels having any plurality of axial width, diameter and offset having an integral disc and rim portion as claimed in claim 30 comprising of well, inner and outer bead seats and inner and outer flanges as described in the description of complete specification and as illustrated by way of drawings accompanying the complete specification, may be produced from the blanks.

51. An apparatus for manufacturing from a steel blank a steel wheel of substantially unitary construction comprising a disc portion and a rim portion, said apparatus comprising:
a. a frame;
b. a rotating component which is substantially rotatably affixed to said frame and which rotates said blank;
c. a clamping component which maintains said steel blank in a substantially fixed position relative to said rotating component; and
d. a forming component, wherein said forming component substantially forms said disc and rim portions into said steel wheel of unitary construction from said steel blank.

52. The apparatus of claim 51, wherein, said forming component forms a well into said rim portion of said unitary wheel.

53. The apparatus of claim 51, wherein, said forming component forms one or more bead seats into said rim portion of said unitary wheel.

54. The apparatus of claim 51, wherein, said forming component forms an inner bead seat and an outer bead seat into said rim portion of said unitary wheel.

55. The apparatus of claim 51, wherein, said forming component forms an inner bead seat and an outer bead seat into said rim portion of said unitary wheel, and wherein said inner and outer bead seats have approximately a 5° or 15° angle.

56. The apparatus of claim 51, wherein, said forming component forms one or more flanges into said rim portion of said unitary wheel.

57. The apparatus of claim 51, wherein, said forming component forms inner and outer flanges into said rim portion of said unitary wheel.

58. The apparatus of claim 51, wherein, said forming component forms a unitary wheel having approximately a 5° or 15° drop center rim.
